(19) United States
(12) Patent Application Publication
(10) Pub. No.: US 2010/0066191 A1
(43) Pub. Date: Mar. 18, 2010

(54) ROTOR AND ELECTRIC MOTOR

(75) Inventors: Hubertus Bähr, Bad Konigshofen (DE); Hans-Joachim Müller, Burkardroth (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, MUENCHEN (DE)

(21) Appl. No.: 12/530,941

(22) PCT Filed: Mar. 11, 2008
(86) PCT No.: PCT/EP08/52839

§ 371 Date: Sep. 11, 2009

(30) Foreign Application Priority Data
Mar. 13, 2007 (DE) 10-2007-012-076.3

(51) Int. Cl. H02K 1/27

(52) U.S. Cl. 310/156.38

(57) ABSTRACT

The invention relates to a rotor (10) for an electric motor, wherein at least two permanent magnets (18 and 18′) are arranged behind each other in the axial direction (with respect to an axis of rotation (16) of the rotor (10)), instead of a single continuous permanent magnet. Said permanent magnets are separated from each other by an electrically non-conductive separator (20). Thus eddy current losses are reduced and heating of the permanent magnets, caused by the eddy current losses, is greatly prevented. The separator (20) contributes also to increased positioning accuracy of the permanent magnets.

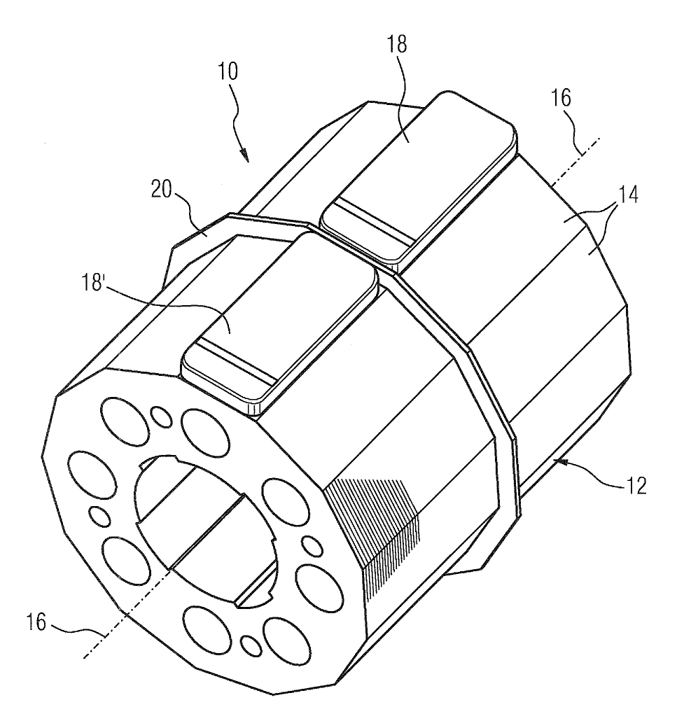

The invention relates to a rotor for an electric motor, and to an electric motor in which this rotor is used.

Normally, the shape of a base body of the rotor predetermines a rotation axis of the rotor in order that this rotor can rotate in a stator of the electric motor. A plurality of permanent magnets are arranged on the base body. A stator of the electric motor has magnet coils, and the magnetic field which is produced by the magnet coils causes the rotor to rotate. When current is passed alternately through the magnet coils, the rotor rotates all the time. At the same time that the rotation of the rotor is initiated, the current through the magnet coils causes eddy currents in the permanent magnets. These eddy currents result in heating of the permanent magnets, which is undesirable. In principle, it is possible to design the permanent magnets to be smaller, in order in this way to minimize eddy currents. However, permanent magnets which touch one another act like one cohesive magnet, and this also results in the formation of eddy currents.

The object of the invention is to considerably reduce the eddy currents in the permanent magnets in a rotor and in an electric motor having a rotor such as this, and thus to prevent excessive heating of the permanent magnets.

The object is achieved by a rotor for an electric motor having the features as claimed in patent claim 1, and by an electric motor having the features as claimed in patent claim 3.

In this rotor, at least two permanent magnets are arranged one behind the other in the axial direction. An electrically non-conductive isolating piece is arranged between the two permanent magnets which are arranged one behind the other in the axial direction. This for the first time makes the measure of provision of permanent magnets which are shorter overall worthwhile: the permanent magnets do not interact in the axial direction as a single large permanent magnet, but, because of the electrically non-conductive isolating piece, the eddy currents are formed separately in each of the permanent magnets which are arranged axially one behind the other. This effectively prevents excessive heating of the permanent magnets.

The isolating pieces may be fitted to the base body as webs. However, the embodiment of the base body of the rotor which is normally used is preferably used as the basis for this: this is because a base body normally comprises a sequence of individual laminate parts in the axial direction. The individual laminate parts are electrically isolated from one another by an insulating coating. Only one of the individual laminate parts now need be larger than the other individual laminate parts on the plane at right angles to the rotation axis of the rotor. Because of the insulating coating, what projects from this larger individual laminate part acts as an electrically non-conductive isolating piece.

The invention also includes an electric motor having a stator and a rotor according to the invention.

One preferred embodiment of the invention will be described in the following text with reference to the drawing, which shows a perspective view of a rotor according to the invention.

A rotor which is annotated 10 in its entirety comprises a base body 12. The base body 12 is nothing more than a rotor laminated core composed of a sequence of individual laminates in the axial direction, as is known from the prior art. A multiplicity of flat surfaces 14 are formed on the base body 12 such that the base body 12 has a polygonal cross section at right angles to the direction of a rotation axis 16 of the rotor. Permanent magnets can be mounted on each of the surfaces 14, with two permanent magnets 18 and 18′ being illustrated in the present case, which are arranged one behind the other in the axial direction (parallel to the axis 16). The two permanent magnets 18 and 18′ are isolated by an isolating piece 20. In principle, it will be possible to provide a specific isolating piece for each of the surfaces 14, which could be attached to the base body 12 like a web. However, in the present case, one of the laminates from the rotor laminated core which forms the base body 12 has a somewhat larger cross section than the other laminates. That part which projects out of the surface 14 in fact represents the isolating piece 20. A circumferential edge is thus provided as a single isolating piece for all the permanent magnets which are mounted on the surfaces 14 (and which are not illustrated, with the exception of the permanent magnets 18 and 18′).

The isolating piece 20 has an electrically insulating coating. The permanent magnets 18 and 18′ are therefore electrically isolated from one another. An eddy current which is formed in the permanent magnet 18 has no influence on the permanent magnet 18′, and an eddy current which is formed in the permanent magnet 18′ has no influence on the permanent magnet 18. The permanent magnets on successive surfaces 14 in the rotation direction of the rotor 10 do not touch one another, in any case. The formation of eddy currents is particularly critical along the axial direction of the rotor 10. In the present case, the figure shows a rotor 10 with a single isolating piece 20. It is, of course, possible to arrange three or more permanent magnets one behind the other in the axial direction, and to separate each by a specific isolating piece.

The use of the isolating pieces also has the advantage that the isolating piece can act as a position stop for the permanent magnets 18 and 18′, because of its flat surface. This allows the axial position of the individual permanent magnets to be fixed particularly precisely. This has positive effects on the torque ripple of the motor. This therefore results in an electric motor with a rotor 10 in which the permanent magnets are not heated as severely as in the prior art, and in which the motor has better torque ripple.

1.-3. (canceled)

4. A rotor for an electric motor, comprising:
a base body defining a rotation axis;
a plurality of permanent magnets arranged radially externally on the base body, wherein at least two permanent magnets on the base body are arranged one behind the other in an axial direction; and
an electrically non-conductive isolating piece arranged between the two permanent magnets.

5. The rotor of claim 4, wherein the base body has a sequence of individual laminate parts in the axial direction which are electrically isolated from one another by an insulating coating on the individual laminate parts, wherein one of the individual laminate parts is larger than the other individual laminate parts on a plane at right angle to the rotation axis to thereby provide the isolating piece.

6. An electric motor, comprising:
a stator; and
a rotor interacting with the stator and including a base body defining a rotation axis, a plurality of permanent magnets arranged radially externally on the base body, wherein at least two permanent magnets on the base body are arranged one behind the other in an axial direction, and an electrically non-conductive isolating piece arranged between the two permanent magnets.

7. The electric motor of claim 6, wherein the base body has a sequence of individual laminate parts in the axial direction which are electrically isolated from one another by an insulating coating on the individual laminate parts, wherein one of the individual laminate parts is larger than the other individual laminate parts on a plane at right angle to the rotation axis to thereby provide the isolating piece.
